(19) United States
(12) Patent Application Publication
(10) Pub. No.: US 2007/0096419 A1
(43) Pub. Date: May 3, 2007

(54) Wheel guide joint

(76) Inventors: Matthias Gercke, Affinghausen (DE); Michael Muhl, Lengerich (DE)

Correspondence Address: MCGLEW & TUTTLE, PC, P.O. BOX 9227, SCARBOROUGH STATION, SCARBOROUGH, NY, 10510-9227, US

(21) Appl. No.: 10/597,881

(22) PCT Filed: Feb. 11, 2005
(86) PCT No.: PCT/DE05/00243

§ 371 Date: Aug. 10, 2006

(30) Foreign Application Priority Data
Feb. 12, 2004 (DE) 10 2004 007 127.6

(51) Int. Cl. B62D 7/16; F16C 11/00

(52) U.S. Cl. 280/93.511; 403/131; 280/93.512

(57) ABSTRACT

A joint arrangement is provided for a wheel guide, especially for a driven, steerable axle of a motor vehicle. The joint arrangement includes a joint fork (1), which can be arranged at a vehicle axle or at a wheel carrier, and a steering knuckle (2), which carries the wheel bearing (3), wherein the joint fork (1) and the steering knuckle (2) are pivotably connected to one another via two mounting points (4), (5). At least one of the two mounting points (4), (5) of the joint arrangement has a toroidal roller bearing. Especially the wheel guiding and the axle geometry of driven, steered axles is improved with the present invention. While the mounting properties are improved, both the design effort for the wheel suspension and the space needed for the installation of the joint arrangement can thus be reduced. The construction contributes to optiation of the axle kinematics, safety, cost effectiveness and reduced maintenance requirement of wheel suspensions as well as to the improvement of the comfort of the vehicle.

### CROSS REFERENCE TO RELATED APPLICATIONS

This application is a United States National Phase application of International Application PCT/DE 2005/000243 and claims the benefit of priority under 35 U.S.C. § 119 of DE 10 2004 007 127.6 filed Feb. 12, 2004, the entire contents of which are incorporated herein by reference.

### FIELD OF THE INVENTION

The present invention pertains to a joint arrangement for guiding a wheel, especially for a driven, steerable axle of a motor vehicle.

### BACKGROUND OF THE INVENTION

Joint arrangements of the type mentioned in the introduction are used, for example, in so-called divided wheel carriers of, e.g., McPherson axles, damper strut axles or double wishbone axles. Such divided wheel carriers are characterized in that a pivotable insert, for example, a steering knuckle, which performs the actual steering motion of the wheel, is arranged at a stationary part of the wheel carrier, i.e., at a part that cannot perform steering motions.

Such divided wheel carriers offer especially the advantage that the steering type axle, about which the wheel is pivoted during the steering motion, can be arranged with a smaller inclination angle as well as closer to the center plane of the wheel, even without an undesired large and/or positive roll radius developing as a result at the same time. This reduces disturbing effects of the driving and braking torques as well as the effects of unevennesses of the road surface, wheel imbalance or centrifugal forces on steering. Moreover, the entire axle geometry, especially the cooperation of inclination, roll radius, track width and king pin angle as well as axle pin rake can thus be better optied in order to guarantee optimal guiding of the vehicle as well as fine steerability free from forces of reaction under all driving conditions and in the widest possible range of steering angles.

Such divided wheel carriers are known, for example, from the documents U.S. Pat. No. 6,042,294 A1 and U.S. Pat. No. 6,010,272 A1. These prior-art wheel carriers comprise two ball and socket joints, by which the steering axis or pivot axis of the steering knuckle is determined. According to the teaching of these documents, the steering knuckle can thus be pivoted about the steering axis determined by the two ball and socket joints in relation to a fork-shaped joint arrangement arranged at the wheel carrier, as a result of which the corresponding wheel of the vehicle performs the steering motion.

However, the wheel guide joint formed by the two ball and socket joints must always be designed by necessity as a fixed/movable bearing combination in order to make it possible to absorb the inevitable manufacturing and assembly tolerances as well as the deformations of the joint and axle components, which always occur during operation. This is all the more true as such wheel guide joints must be designed, especially in case of driven axles, essentially with a fork-shaped opening in order to make possible the necessary passage for the drive shaft of the wheel. However, this open, fork-shaped design brings with it additional elasticities, which are manifested in deformations of the joint fork and the respective bearing flanges as soon as effects of the road surface as well as driving, braking and centrifugal forces act on the wheel guide joint.

However, fixed/movable bearing combinations are often problematic, especially because of the necessity of simultaneously absorbing oblique positions and axial displacements in the area of the movable bearing. To absorb oblique positions as well as axial displacements of a shaft or axle, it is necessary according to the state of the art to provide two different bearing surface areas in the area of the movable bearing. One of the bearing surface areas is responsible here specifically for absorbing the oblique positions and the other bearing surface area specifically for absorbing the axial displacements.

In this case of a wheel guide joint comprising two ball and socket joints, this means that one of the ball and socket joints must additionally be provided with a means for absorbing axial displacements of the ball pin and the ball shell in relation to the joint housing. This means for absorbing axial displacements means nothing else but the need for another, essentially prismatic bearing surface, in addition to the ball shell bearing surface between the ball pin and the ball shell.

However, this additionally necessary bearing surface brings with it a considerable design effort and does, of course, require additional space for installation, which is available, however, to an extremely limited manner only in the wheel guide joint in question, which is arranged mostly within the wheel rims. In addition, additional radial bearing clearance, which must in turn be counteracted by frequently complicated design measures, is introduced into the joint arrangement due to the bearing surface that is additionally necessary for absorbing the axial displacements.

### SUMMARY OF THE INVENTION

Against this background, the object of the present invention is to provide a joint arrangement with which the drawbacks can be overcome. The joint arrangement shall simplify especially the design measures necessary for the simultaneous absorption of axial displacements and oblique positions between the individual components of the joint. Furthermore, the joint arrangement shall be able to be designed as a compact, clearance-free and low-cost joint arrangement requiring little maintenance as much as possible.

The joint arrangement according to the present invention comprises, in the manner known per se, a joint fork that can be arranged at a vehicle axle or at a wheel carrier as well as a steering knuckle receiving the wheel bearing. The joint fork and the steering knuckle are pivotingly connected to one another by two axially aligned mounting points, as a result of which the corresponding wheel of the vehicle performs the steering motion.

However, the joint arrangement is characterized according to the present invention especially in that at least one of the two mounting points, with which the joint fork and the steering knuckle are pivotably connected, has a toroidal roller bearing.

In other words, this means that especially the movable bearing of the joint arrangement is formed by a toroidal roller bearing. The type of the fixed bearing of the joint arrangement is not decisive for the essence of the present invention as long as the fixed bearing can absorb all the axial forces of the joint and transmit same between the steering knuckle and the joint fork as intended.

Toroidal roller bearings have the property, unique in the area of rolling bearings, of being able to absorb both axial displacement and incorrect angular positions solely by a corresponding automatic relative motion of the inner ring, the outer ring and the rolling bodies. Neither the frictional forces nor stick-slip effects known for usual movable bearings, which lead to undesired vibrations or loads of the rolling surfaces, occur in case of axial displacements. The compensating motions of the bearing components of the toroidal roller bearings are also not associated with non-uniform surface pressure or with the development of harmful edge pressure in the area of the rolling bodies.

Because of the always uniform linear contact between the toroidal concave bearing rings and the crowned rolling bodies, the toroidal roller bearing also has an extremely high bearing capacity. Moreover, the toroidal roller bearing is always nearly free from clearance because of its special geometry, independently from incorrect angular positions and independently from the axial displacement absorbed, which is favorable for the quiet running of the wheel and the sensitiveness and the absence of interaction of the steering.

The great advantage of the use of a toroidal roller bearing according to the present invention as a movable bearing in a joint arrangement for a wheel guide is that all incorrect angular positions and axial displacements, which occur in the area of the wheel guide joint, for example, because of tolerances as well as because of deformations caused by forces during the operation of the vehicle, can be absorbed in the area of a single bearing surface arrangement. The additional prismatic bearing surface for absorbing axial displacements in the area of the movable bearing, which was always necessary according to the state of the art, can thus be eliminated without replacement.

However, the great design effort associated with this additional bearing surface is also eliminated at the same time. In addition, the need for a considerable amount of installation space is eliminated, as a result of which the joint arrangement according to the present invention can also be used in smaller vehicles and with smaller rim inner diameters. Last but not least, the additional radial bearing clearance associated with the previously additionally necessary bearing surface is also eliminated, which improves quiet running, the absence of needed maintenance and the service life of a motor vehicle axle of such a design.

The design of the other mounting point of the joint arrangement forming the fixed bearing is freely selectable according to the present invention as long as this other mounting point can absorb and transmit all the forces acting in the axial direction of the joint between the joint fork and the steering knuckle. However, according to a preferred embodiment of the present invention, the other mounting point forming the fixed bearing is designed as a ball and socket joint. Since this ball and socket joint acting as a fixed bearing does not have to absorb any axial displacement, it can be designed as a compact and robust ball and socket joint with little clearance and high bearing capacity.

According to another preferred embodiment of the present invention, the toroidal roller bearing is arranged in a pot-shaped recess of the joint fork or of the steering knuckle, the pot-shaped recess preferably having a peripheral collar in the area of the bottom of the recess. This arrangement is advantageous insofar as the toroidal roller bearing is thus seated in a defined manner due to being simply pressed into the pot-shaped recess, and the toroidal roller bearing is already sealed completely against the environment on the bottom side of the recess by the bottom of the recess. The peripheral collar ensures defined axial seating of the toroidal roller bearing in the pot-shaped recess. Moreover, it is ensured in this manner that the clearance necessary for absorbing axial displacement is left available for the inner ring of the toroidal roller bearing and for the end of the pivot pin of the steering knuckle. Furthermore, this cavity can be used as an additional reservoir for receiving lubricant for the toroidal roller bearing.

To further improve the comfort properties as well as to prolong the service life of the joint arrangement, provisions are made according to another embodiment of the present invention for arranging at least one elastic body between the outer ring of the toroidal roller bearing and the essentially cylindrical wall of the pot-shaped recess. This at least one elastic body, which is preferably in the form of one or more elastic rings of an essentially circular cross section, leads to a certain vibration damping and uncoupling between the steering knuckle and the joint fork. This is also favorable for driving comfort as well as the reduction of the noise of the vehicle axle provided with the joint arrangement. The elastic ring or the elastic rings may be able to be received now especially in grooves, which were provided peripherally on the surface of the outer ring of the bearing and/or on the inner surface of the wall of the pot-shaped recess.

According to another preferred embodiment of the present invention, the toroidal roller bearing is covered with a seal on the side facing away from the bottom of the pot-shaped recess. The seal seals both the rolling bodies and the rolling surfaces of the toroidal roller bearing and the gap between the outer ring of the bearing and the pot-shaped recess as well as the gap between the inner ring of the bearing and the bearing journal against environmental effects. This is advantageous because the entire movable bearing area can thus be protected and encapsulated completely with only one seal.

The seal especially advantageously has a first edge and a second edge or sealing lip in the area of its inner circumference. The seal is supported with the first edge or sealing lip radially on the bearing journal. With the second edge or sealing lip, the seal is supported axially at the collar of the bearing journal. This leads to an especially effective and reliable closure of the toroidal roller bearing against any environmental effects, especially also when axial displacements occur between the steering knuckle and the joint fork in the area of the toroidal roller bearing during the operation of the joint arrangement.

The present invention will be explained in more detail below on the basis of a drawing showing only one exemplary embodiment.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic view of an embodiment of a joint arrangement according to the present invention in a partly cut-away side view.

### DESCRIPTION OF THE PREFERRED EMBODIMENTS

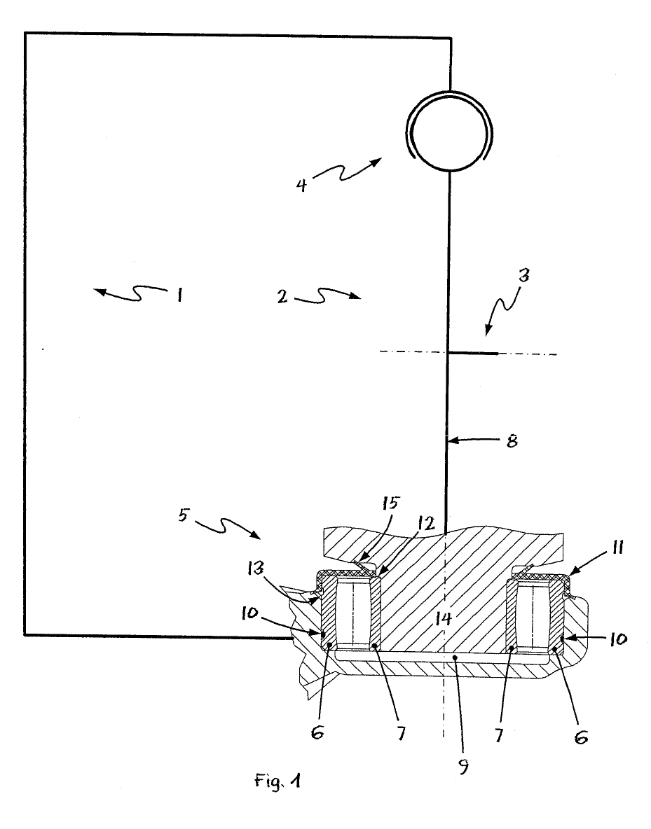

Referring to the drawings in particular, FIG. 1 shows an embodiment of a joint arrangement according to the present invention with view along the direction of travel of a corresponding motor vehicle. The only very schematically outlined arrangement comprising a joint fork 1 and a steering knuckle 2 can be recognized, the arrangement being shown neither true to scale nor isogonally. The joint fork 1 is connected, on the left side in the drawing, for example, to a spring strut, not shown, while the steering knuckle 2 carries the bearing of the wheel equipped with the joint, likewise not shown, at 3 in the right-hand part of the drawing. The joint fork 1 and the steering knuckle 2 have two common mounting points 4 and 5, one of the mounting points being designed as a ball and socket joint 4 and the other mounting point being provided with a rolling bearing 5.

The rolling bearing 5 is designed as a toroidal roller bearing according to the preferred embodiment, which does, as was already described in the introduction, tolerate a certain angular displacement between its outer ring 6 and its inner ring 7 as well as can absorb axial displacements of the inner ring 7 in relation to the outer ring 6 without problems and without forces of reaction.

By contrast, the ball and socket joint 4 forms the fixed bearing of the fixed/movable bearing combination shown and is responsible for absorbing and transmitting the forces acting in the axial direction of the joint between the steering knuckle 2 and the joint fork 1.

Rather substantial forces and bending moments, which originate, among other things, from the driving force of the vehicle, are generated by centrifugal forces during travel in curves, are caused by the braking torques or develop due to the effects of unevennesses in the road surface, develop in the area of the wheels and axles during the travel of a vehicle.

These forces and bending moments must be absorbed by the steering knuckle 2 and transmitted to the joint fork 1. However, rather substantial elastic deformations develop now both in the steering knuckle 2 itself and in the joint fork 1. These lead to deflections of the joint axis 8, to deaxing and eccentricities of the axes of the two joints 4, 5 as well as to elastic winding-up of the joint fork 1, and the latter, in particular, leads to an increase in the distance between the two joints 4, 5.

Added to this are also inevitable component tolerances as well as additional tolerances, which develop during the installation of the joint arrangement. All these incorrect positions, deformations and displacements can be absorbed without problems by the movable bearing 5 of the joint arrangement design as a toroidal roller bearing, without harmful forces of reaction or even edge pressing, which would additionally load the bearing components and shorten their service life, developing as a result.

It also appears from FIG. 1 that the movable bearing 5 as a toroidal roller bearing can also be designed as a toroidal roller bearing in an especially compact manner. Compared to the hitherto complicated ball and socket joints with axial compensation, in particular, considerable installation space can thus be saved. This also makes it possible to use the joint arrangement according to the present invention in smaller vehicles and in case of smaller rim diameters.

The reduction of the dimensions of the movable bearing 5, which is possible according to the present invention, is linked especially with the fact that the toroidal roller bearing has an especially high specific bearing capacity and it can thus be designed as a comparatively compact toroidal roller bearing. Furthermore, the reduction of the space needed for installation also results from the fact that both incorrect angular positions and axial displacement can be absorbed in one and the same bearing surface arrangement of the toroidal roller bearing, unlike in the case of the special ball and socket joints that were hitherto necessary. Furthermore, the arrangement of the toroidal roller bearing in a cylindrical pot-shaped recess 9 of the joint fork 1 contributes to the compact design. This arrangement has, in particular, the advantage of high rigidity, and, moreover, the side of the toroidal roller bearing that faces away from the bearing journal and is the lower side in relation to the drawing already offers complete coverage, so that no further sealing measures are thus necessary on this side.

FIG. 1 also shows, moreover, that an elastic element 10, for example, one or more elastic ring 10, can be arranged between the outer ring 6 of the toroidal roller bearing and the cylindrical wall of the pot-shaped recess 9. The elastic element 10 can thus additionally improve the vibration uncoupling between the steering knuckle 2 and the joint fork 1 and thus guarantee better buffering of force peaks. In addition, the transmission of rolling noises in the form of structure-borne noise via the joints of the wheel suspension can thus be reduced or damped.

Finally, FIG. 1 also shows the type and the design of the seal 11, which covers the entire steering knuckle-side bearing area of the movable bearing 5. The seal 11 shown is especially advantageous insofar as both the rolling surfaces and the rolling bodies of the toroidal roller bearing are thus completely protected with only one sealing element 11 and the gaps 12, 13 between the bearing rings 6, 7 of the toroidal roller bearing and the respective press fit of the bearing rings 6, 7 in the pot-shaped recess 9 and on the bearing journal 14 of the steering knuckle 2, which said gaps tend to be susceptible to corrosion.

The seal 11 is supported now in the area of the steering knuckle bearing journal 14 both radially at 12 on the bearing journal 14 and axially at 15 at the collar of the bearing journal 14. This leads to an especially reliable sealing action, on the one hand, and guarantees, on the other hand, that the seal 11 is reliably in contact with the respective sealing surfaces 12, 13, 15 under all operating conditions, especially also in case of deflections of the joint axis 8 and/or axial displacements between the bearing journal 14 and the joint fork 2.

It thus becomes clear as a result that thanks to the present invention, the design of joint arrangements for wheel suspensions, especially for steerable driven axles of motor vehicles, can be substantially simplified and improved. Both the design effort needed for such joint arrangements and the space needed for installation are now reduced, and, moreover, a considerably prolonged service life, reduced maintenance requirement as well as better comfort properties can be expected from the joint arrangement according to the present invention. Despite the improvements made possible by the present invention, costs can also be saved at the same time thanks to the present invention in terms of the design, manufacture and operation of wheel suspensions and axle systems.

Thus, the present invention makes an essential contribution to the improvement of wheel guiding and the optiation of the axle kinematics, which is beneficial for the safety, the cost effectiveness, the reduction in the maintenance requirement and the driving comfort of wheel suspensions on the motor vehicle.

While specific embodiments of the invention have been shown and described in detail to illustrate the application of the principles of the invention, it will be understood that the invention may be embodied otherwise without departing from such principles.

1. A wheel guide joint arrangement for a driven axle of a motor vehicle, the joint arrangement comprising:
a joint fork, which can be arranged at a vehicle axle or at a wheel carrier;
a steering knuckle carrying a wheel bearing; and
a pivotable connection between said joint fork and said steering knuckle two mounting points aligned with one with one of said two mounting points having a toroidal roller bearing.

2. A joint arrangement in accordance with claim 1, wherein one of said two mounting points has a ball and socket joint.

3. A joint arrangement in accordance with claim 1, wherein said toroidal roller bearing is arranged in a pot-shaped recess of said joint fork or of said steering knuckle.

4. A joint arrangement in accordance with claim 3, wherein said pot-shaped recess of said joint fork or of said steering knuckle has a peripheral collar in the area of the bottom of said recess.

5. A joint arrangement in accordance with claim 3, further comprising an elastic body arranged between an outer ring of said toroidal roller bearing and an essentially cylindrical wall of said pot-shaped recess.

6. A joint arrangement in accordance with claim 5, wherein said elastic body is a ring with an essentially circular cross section.

7. A joint arrangement in accordance with claim 3, wherein said toroidal roller bearing is covered with a seal on the side facing away from the bottom of said pot-shaped recess, wherein said seal seals both the rolling bodies of said toroidal roller bearing and a gap between said bearing outer ring and said pot-shaped recess and another gap between said bearing inner ring and said bearing journal against environmental effects.

8. A joint arrangement in accordance with claim 7, wherein said seal has a first edge or lip as well as a second edge or lip in the area of an inner circumference adjacent to said another gap, wherein said seal is supported with the first edge radially at said bearing journal and with said second edge axially at said collar of said bearing journal.
